(19) United States
(12) Patent Application Publication
(10) Pub. No.: US 2020/0213576 A1
(43) Pub. Date: Jul. 2, 2020

(54) AUTOMATED CALIBRATION TARGET STANDS

(71) Applicants: OREGON STATE UNIVERSITY, Corvallis, OR (US); HEWLETT-PACKARD DEVELOPMENT COMPANY, L.P., Spring, TX (US)

(72) Inventors: Daniel Mosher, Corvallis, OR (US); Brian Bay, Corvallis, OR (US); David A. Champion, Lebanon, OR (US)

(21) Appl. No.: 16/608,396

(22) PCT Filed: Sep. 14, 2017
(86) PCT No.: PCT/US2017/051580

§ 371 Date: Oct. 25, 2019

(51) Int. Cl. H04N 13/246; H04N 13/296; B33Y 50/02; B29C 64/393

(52) U.S. Cl. CPC H04N 13/246; B29C 64/393; B33Y 50/02; H04N 13/296

(57) ABSTRACT

Example methods, apparatus, systems, and articles of manufacturing for calibrating a stereo vision system are described herein. An example stereo vision calibration system includes an automated calibration target stand to support a calibration target. The example stereo vision calibration system further includes a calibrator to control the automated calibration target stand to move the calibration target to a plurality of positions according to a sequence of positions while the automated calibration target stand is disposed in an additive manufacturing (AM) machine, and control a stereo vision system of the AM machine to obtain images of the calibration target in the plurality of positions.

### BACKGROUND

Additive manufacturing machines, commonly referred to as 3D printers, may be used to produce three-dimensional objects. In some examples, the three-dimensional objects are produced in layers using build material.

### BRIEF DESCRIPTION OF THE DRAWINGS

FIG. 1 illustrates an example calibration system, including an example automated calibration target stand and an example calibrator, implemented in connection with an example stereo vision system of an example additive manufacturing machine and constructed in accordance with the teachings of this disclosure.

FIG. 2A is a perspective view of the example automated calibration target stand of the example calibration system of FIG. 1.

FIG. 2B is a side view of the example automated calibration target stand of FIG. 2A.

FIG. 3 illustrates an example calibration target that may be used with the example calibration system of FIG. 1.

FIG. 4 illustrates an example geometry that may be used to select a calibration target for the example calibration system of FIG. 1.

FIGS. 5 and 6 illustrate example geometries that may be used to determine positions of a calibration target for calibrating the example stereo vision system of FIG. 1 and which may be implemented by the example calibration system of FIG. 1.

FIG. 7 illustrates example axes of rotation that may be used to select positions for a calibration target during a calibration process implemented by the example calibration system of FIG. 1.

FIG. 8 is a flowchart representative of machine readable instructions that may be executed to implement the example calibrator of FIG. 1 to perform an example calibration process.

FIG. 9 is a flowchart representative of machine readable instructions that may be executed to implement the example calibrator of FIG. 1 to determine an optimal sequence of positions for a calibration process.

FIG. 10 is a processor platform that may execute the example instructions of FIGS. 8 and 9 to implement the example calibrator of FIG. 1.

The figures are not to scale. Wherever possible, the same reference numbers will be used throughout the drawing(s) and accompanying written description to refer to the same or like parts. While the drawings illustrate examples of printers and associated controllers, other examples may be employed to implement the examples disclosed herein.

### DETAILED DESCRIPTION

Disclosed herein are example methods, apparatus, systems, and articles of manufacturing for calibrating a stereo vision system. In general, a stereo vision system includes the use of two cameras, spaced apart from each other, that obtain digital images of a common area, referred to herein as a field of view (FoV). Stereo vision systems are used to extract depth information, such as 3D features, of the scene in the FoV.

Disclosed herein are example additive manufacturing (AM) machines, commonly referred to as 3D printers, that utilize stereo vision systems to extract depth information relating to the build process being performed by the additive manufacturing system. The stereo vision system may be used, for example, to ensure the spread of build material (e.g., metallic powder) is sufficiently even or level, thereby increasing the accuracy of a 3D object being generated. Additionally or alternatively, the stereo vision system may be used to ensure that each hardened layer of the 3D object is sufficiently level or even. As the accuracy of the stereo vision system affects the accuracy of the depth information extraction process, proper calibration of the stereo vision system ensures accurate results during the depth information extraction process.

Traditionally, a stereo vision system is calibrated by holding a calibration target in the FoV and taking a plurality of images with the cameras with the calibration target in different orientations. The calibration target may include, for example, a known grid or patter of features. The images of the calibration target are analyzed by a processor and may be used to determine one or more of extrinsic parameters of the cameras, intrinsic parameters of the cameras, and distortion coefficients. These parameters may then be used to extract depth information from the FoV during use of the stereo vision system. However, the process of manually holding the calibration target and moving the calibration target through the plurality of positions is time consuming and cumbersome. Further, this process is subject to human error and often has to be repeated.

Disclosed herein are example automated calibration target stands that support a calibration target and move the calibration target to the plurality of positions for calibrating a stereo vision system. An example automated calibration target stand includes a platform to which the calibration is to be mounted. The platform is tiltable and rotatable using two motors. The example automated calibration target stand, along with the calibration target, may be placed into the AM machine in the FoV of the stereo vision cameras. The example automated calibration target stand moves the calibration target to the plurality of positions (e.g., tilts, rotations, etc.) and the stereo vision cameras obtain images of the calibration target in the different positions. The example automated calibration target stand enables high precision in positioning the calibration target and enables high repeatability of the same positions and/or sequence of positions.

In some examples, the automated calibration target stand is part of a calibration system that includes a calibrator. The calibrator manages the position(s) and/or sequence of positions and controls the movement automated calibration target stand. In some examples, the calibrator is implemented as a software program or application operated on a computer. In some examples, the automated calibration target stand is placed into an AM machine and plugged (e.g., via a cord) into the computer. The calibrator executes a calibration process that instructs the automated calibration target stand to move to the position(s) and/or sequence of positions and instructs the stereo vision cameras to obtain images when the calibration target is in the desired positions.

In some examples, the example calibration system can be used to identify positions and/or sequences of positions that result in relatively low calibration error. These positions and/or sequences of positions can be saved and repeated in subsequent calibrations. As such, this process can be used to iteratively refine the calibration process and determine more effective positions and/or sequences of positions that result in a more accurate calibration process. Also disclosed herein are example methods, apparatus, systems, and articles of manufacturing for selecting parameters of a calibration target, determining the boundaries of the tilt positions, and determining the positions and/or sequence of positions to be used while calibration a stereo vision system.

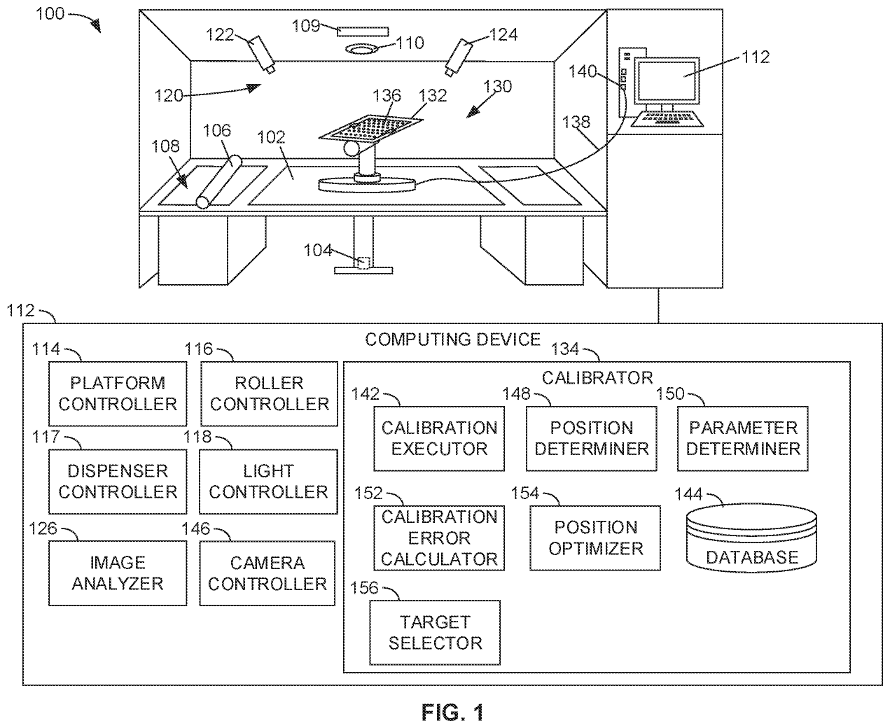

FIG. 1 illustrates an example printer 100 in which the examples disclosed herein may be implemented. In the illustrated example of FIG. 1, the printer 100 is a powder bed based 3D printing system that creates a 3D object by selectively solidifying portions of successively formed layers of material. In the illustrated example, the printer 100 includes a build platform 102 that is moveable up and down via a platform motor 104. To create a 3D object, a roller 106 spreads a thin layer of powder material (sometimes referred to as a build layer) from a reservoir 108 (e.g., a hopper) over the build platform 102. The powder material may be any metal and/or polymer based material. Then, a dispenser 109 (having one or a plurality of nozzles) prints a fusing agent onto the powder material layer in the shape of a cross-section of the 3D object that is to be solidified. The fusing agent may be, for example, a heat absorbing polymer-based chemical. Then, a light 110 (e.g., a lamp) uniformly irradiates the powered bed layer, which causes the area of the powder material with the fusing agent to fuse, solidify, and/or otherwise harden to form a layer of the 3D object, whereas the area of the powder material without the fusing agent remains loose. The dispenser 109 and/or the light 110 may be moved by a combined or separate carriage assembly (e.g., an XY gantry). Next, the build platform 102 is moved downward a small amount, (e.g., 0.1 millimeter (mm)) via the platform motor 104, and the roller 106 spreads another layer of powder material over the build platform 102 and over the first hardened layer. The dispenser 109 again deposits fusing agent onto the powder material layer in the shape of the next cross-section, and the light 110 again applies energy to the layer to harden the material onto the previous layer. This process is repeated to build the 3D object layer-by-layer. The loose, unfused powder material surrounding the 3D object on the build platform 102 remains in position throughout the process and is removed at the end. In some examples, instead of a light, another unfocused energy source such as a heater or laser may be used to activate the fusing agent. While the examples disclosed herein are described in connection with a powder bed fusion AM machine, the examples disclosed herein can likewise be implemented with another any other type of AM process or machine, such as VAT photopolymerisation, selective laser sintering (SLS), material jetting, binder jetting, material extrusion, sheet lamination, and/or directed energy deposition.

In the illustrated example, a computing device 112 is provided that controls the printer 100 to build a 3D object according to a 3D model or build file. In particular, the computing device 112 controls the operations of the printer 100, such as controlling the build platform 102, the roller 106, the dispenser 109, the light 110, and/or any other part of the printer 100. In some examples, the computing device 112 is part of the printer 100 (e.g., coupled to or built into a housing of the printer 100). In other examples, the computing device 112 is separate from the printer 112 and may be electrically coupled to the printer 100 (e.g., via a cord) to interface with the components of the printer 100. The computing device 112 is illustrated twice in FIG. 1, once as a computer and once by a block diagram. The computing device 112 may be implemented as any type of processing platform, such as a personal computer, a laptop computer, a tablet, a cell phone (e.g., a smart phone), etc. In the illustrated example, the computing devices 112 includes a platform controller 114 that controls the platform motor 104 to move the build platform 102, a roller controller 116 that controls the roller 106, a dispenser controller 117 that controls the dispenser 109, and a light controller 118 that controls the light 110. The platform controller 114, the roller controller 116, the dispenser controller 117, and/or the light controller 118 may be implemented as program or application that may be executed by a processor of the computing device 112, for example.

To enhance the accuracy of the building process, the example printer 100 includes an example stereo vision system 120. In the illustrated example, the stereo vision system 120 includes a first camera 122 and a second camera 124 that are spaced from each other and aimed at a common area and have the same FoV. In this example, the FoV includes the build platform 102. The first and second cameras 122, 124 take digital images of the FoV and an image analyzer 126 extracts 3D information based on the image set (one image from each of the cameras 122, 124). In the illustrated example, the image analyzer 126 of the stereo vision system 120 is implemented as a program or application that may be executed by a processor of the computing device 112. To extract 3D depth information, the image analyzer 126 measures the change (e.g., in number of pixels) in a position of a common point or feature between the two images and determines the Z, vertical, height of the point or feature relative to other points or features based on the change. As such, the example stereo vision system 120 can be used to determine the position of a feature in the FoV including changes in the Z height of any objects and/or surfaces in the FoV.

In some examples, the stereo vision system 120 is used to ensure that each layer of the powder material has a substantially uniform thickness. Uneven spreads may cause uneven layers in the generated 3D object and, as a result, can lead to defects and/or undesired features (e.g., a void) in the 3D object. Therefore, in some examples, after each spread of the powder material, the stereo vision system 120 obtains an image set of the layer of powder material. If the image analyzer 126 measures a relatively large variance or anomaly in the Z height of the powder spread, the printer 100 may re-spread the layer of powder material and/or take another course of action. Additionally or alternatively, the stereo vision system 120 may obtain images of the hardened layers after each of the layers is created to ensure each layer is sufficiently even or flat. Therefore, the accuracy of the building process relies on accurate depth measurements from the stereo vision system 120. Thus, proper calibration of the stereo vision system 120 ensures the accuracy of the stereo vision measurements.

In the illustrated example of FIG. 1, an example stereo vision calibration system 130 (referred to herein as the calibration system 130) is provided for calibrating the stereo vision system 120 of the printer 100. The example calibration system 130 includes an automated calibration target stand 132 (referred to here as the stand 132) and a calibrator 134. The stand 132 supports a calibration target 136 and is to be disposed in the printer 100 in the FoV of the cameras 122, 124. The calibrator 134 controls the stand 132 to move the calibration target 136 to a set of defined positions where the stereo vision system 120 can obtain images of the calibration target 136 for calibrating the stereo vision system 120, as disclosed in further detail herein. In particular, the stand 132 can tilt, rotate, and/or otherwise change the orientation and/or location of the calibration target 136 in the FoV of the stereo vision system 120. In the illustrated example, the calibrator 134 is implemented as an application or software program executed by a processor of the computing device 112. Therefore, in some examples, the computing device 112 is part of the example calibration system 130. However, in other examples, the calibrator 134 may be implemented in another electronic device or processing platform (e.g., a tablet, a cell phone, a laptop computer, etc.) that interfaces with the printer 100, the computing device 112, and/or the stand 132. In some examples, the calibrator 134 may be implemented in the stand 132 (e.g., in a processor associated with the stand 132).

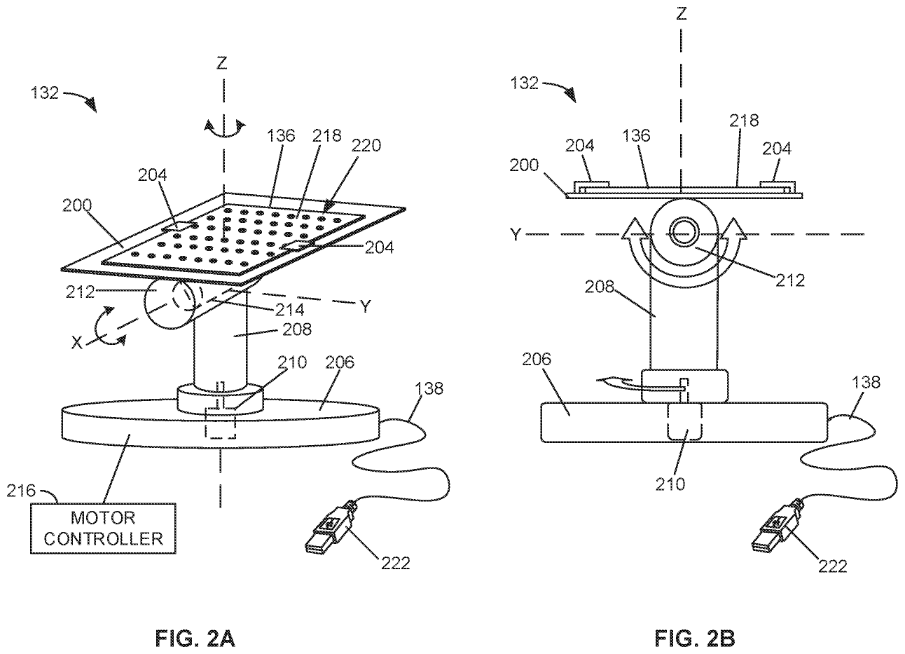

Referring briefly to FIGS. 2A and 2B, FIG. 2A is an enlarged perspective view of the example stand 132 and FIG. 2B is a side view of the example stand 132. As illustrated in FIGS. 2A and 2B, the example stand 132 includes a platform 200 (e.g., a mounting surface, a panel, etc.) to hold or support the calibration target 136. In the illustrated example, the stand 132 includes two clips 204 coupled to the platform 200 that hold the calibration target 136 on the platform 200. In other examples, the stand 132 may include more or fewer clips. Additionally or alternatively, the stand 132 may include other mechanical fasteners and/or chemical fasteners (e.g., an adhesive) to couple the calibration target 136 to the platform 200.

In the illustrated example of FIGS. 2A and 2B, the platform 200 is coupled to a base 206 by a post 208. In particular, the post 208 extends (e.g., perpendicularly) from the base 206 and the platform 200 is coupled to the distal end of the post 208. The example stand 132 includes a first motor 210 (shown in dashed lines) to rotate the post 208 and, thus, the platform 200 and the calibration target 136 about a Z (vertical) axis. In the illustrated example, the rotational Z (vertical) axis extends through a center of the platform 200 and is aligned with a longitudinal axis of the post 208. In the illustrated example, the first motor 210 is disposed in the base 206 of the stand 132. To enable the platform 200 and the calibration target 136 to tilt, the platform 200 is coupled to the post 208 via a joint 212, which defines a horizontal axis of rotation, referred to herein as the X (horizontal) axis. In the illustrated example, the stand 132 includes a second motor 214 (FIG. 2A) (shown in dashed lines) disposed in the joint 212 that rotates the platform 200 about the X (horizontal) axis. The first and/or second motors 210, 214 may be servo motors, for example. In other examples, the first motor 210 and/or the second motor 214 may be implemented as other types of motors. As illustrated in FIG. 2A, the example stand includes a motor controller 216 that activates the first and/or second motors 210, 214 according to instructions provided by the calibrator 134 (FIG. 1), discussed in further detail herein. The motor controller 216 may be disposed in the base 206, for example.

In FIGS. 2A and 2B, the platform 200 and the calibration target 136 are facing upward or perpendicular to the Z axis. The platform 200 may be rotated or titled about the X (horizontal) axis in either direction by the second motor 214 to tilt (angle) the calibration target 136. In some examples, the platform 200 (and, thus, the calibration target 136) may be tilted up to about ±90° from the horizontal position shown in FIGS. 2A and 2B. Additionally or alternatively, the platform 200 may be rotated about the Z (vertical) axis in either direction by the first motor 210 to spin or rotate the calibration target 136 about the Z (vertical) axis (e.g., from 0°-360°). Further, in some examples, the stand 132 may include additional degrees of freedom. For example, the platform 200 may also be tiltable about a horizontal Y axis, which is perpendicular to the X axis in FIG. 2A. In such an example, the platform 200 (and, thus, the calibration target 136) may be rotatable or tiltable about three axes XYZ, which enables the calibration target 136 to be positioned in various orientations. In the illustrated example, the calibration target 136 includes a substrate 218, such as a piece of paper or cardboard, with a grid pattern 220 having a plurality of dots. The dimensions of the calibration target 136 and the grid pattern 220 (e.g., the size of the dots, spacing between the dots, etc.) are known and used when calibrating the stereo vision system 120, as disclosed in further detail herein. In other examples, other types of calibration targets have other patterns may be used. For example, other calibration targets may include a check board pattern or a line grid pattern (where the line intersections become points that are detected). In some examples, instead of a coupling a calibration target to the platform 200 of the stand 132, a calibration target may be formed on the platform 200. For example, the grid pattern 220 may be printed directly on the platform 200.

Referring back to FIG. 1, to calibrate the stereo vision system 120 of the printer 100, the calibration target 136 may be coupled to the platform 200 (e.g., by sliding the calibration target 136, for example printed on a suitable substrate, under the clips 204 (FIG. 2A)) and the stand 132 may be placed onto the build platform 102 of the printer 100. In the illustrated example, the stand 132 includes a cable 138 (e.g., a cord) that can be plugged into the computing device 112 to electrically couple the stand 132 and the computing device 112. As illustrated more clearly in FIGS. 2A and 2B, the cable 138 includes a plug 222, such as a Universal Serial Bus (USB) plug (e.g., a Type A plug), that can plug into corresponding an input/output (I/O) port 140 (FIG. 1) (e.g., a USB port) on the computing device 112. In other examples, the cable 138 may include any other type of connector. Referring back to FIG. 1, the calibrator 134 and the stand 132 communicate (e.g., send signals) via the cable 138. In other examples, the stand 132 may include a wireless transceiver to communicate with the computing device 112 wirelessly (e.g., via Bluetooth®, over a network such as the Internet, etc.). In some examples, the stand 132 is powered by the computing device 112 through the cable 138. For example, the stand 132 may be powered by the I/O port 140 (e.g., via a Power Delivery (PD) controller of the I/O port 140) of the computing device 112. In other examples, the stand 132 may include a separate power plug and/or a power supply (e.g., a battery).

In the illustrated example of FIG. 1, the calibrator 134 includes a calibration executor 142 that controls the stand 132 to move the platform 200 (FIG. 2) (and, thus, the calibration target 136) to one position or a plurality of positions of a sequence for calibrating the stereo vision system 120. The calibration position(s) may be stored in a database 144 of the calibrator 134, for example. Each position may be defined by a rotational angle about the X, Y, and/or Z axes and/or a linear position along the X, Y, and/or Z axes within the FoV relative to the first and/or second cameras 122, 124, as disclosed in further detail herein. In some examples, a calibration process may include only one position. In other examples, a calibration process may include a plurality of positions, referred to herein as a set or sequence of positions. In some examples, the positions are to be performed in a particular order. In other examples, a plurality of positions may be performed in any order. When a calibration process is initiated, the calibration executor 142 controls the stand 132 to move the platform 200 (and, thus, the calibration target 136) to a first position of the sequence. For example, the calibration executor 142 may send a control signal to the motor control 216 (FIG. 2) to activate the first and/or second motor 210, 214 to position the calibration target 136 in the desired orientation. Once the platform 200 (FIG. 2) (and, thus, the calibration target 136) is in the desired position, the calibration executor 142 controls the first and second cameras 122, 124, via a camera controller 146, to obtain a digital image with each of the cameras 122, 124. After the image set is obtained, the calibration executor 142 controls the stand 132 to move the platform 200 (FIG. 2) (and, thus, the calibration target 136) to a second position or orientation of the sequence, and so forth, until image sets of the calibration target 136 are obtained for each of the positions in the sequence.

In some examples, prior to beginning a calibration sequence, the calibration executor 142 instructs the user where to position the stand 132 on the build platform 102. For example, the build platform 102 may include guide marks (e.g., a grid with XY coordinates) and/or positioning hardware (e.g., indexing pins and holes, matched projections and depressions, edges to position the base 206 against, etc.) that enable a user to accurately place the stand 132 in a specific XY location on the build platform 102. The initial position may be displayed on a display screen of the computing device 112, for example. In other examples, the stand 132 may be placed anywhere on the build platform 102 and, during the calibration process, the calibrator 134, which determines where the calibration target 136 is located in space, may calculate the transformations that yield the desired set of motions. In some such examples, the calculation accounts for the rigid body motion between the actual and expected initial position of the calibration target 136, based on an initial image pair. The expected initial position of the calibration target 136 may be the center of the build platform 102, with the dot grid rows and columns in the Y and X directions, for example.

As disclosed herein, a calibration process may include obtaining images of the calibration target 136 in multiple positions, where each position is defined by a specific orientation of the calibration target 136 (defined by the rotational angles about the X, Y, and/or Z axes) and/or and a specific location in the FoV (defined by the XYZ location of the calibration target 136 in the FoV relative to the first and second cameras 122, 124). As a result, multiple images of the calibration target 136 may be obtained with the calibration target 136 in different orientations and locations in the FoV. In some examples, the stand 132 is placed in a first XY location on the build platform 102 and a calibration sequence (e.g., a first position or set of positions) is performed with the stand 132 (by rotating the platform 200 about the X and Z axes in FIG. 2A). Then, after the calibration sequence is performed, the stand 132 is moved (e.g., via a user) to another XY location on the build platform 102 and the same or another calibration sequence (e.g., a second position or set of positions) may be performed. For example, the calibration executor 142 may indicate to a user to move the stand 200 to another XY location on the build platform 102. In some instances, the calibration target 136 is smaller than the FoV of the stereo vision system 120. As such, the stand 132 may be moved to another location in the printer 100 so that the calibration target 136 is disposed in another area in the FoV. In some such examples, the same or another calibration sequence may be performed by the example calibration system 130. In some examples, the stand 132 may include another degree of freedom to move the platform 200 (and, thus, the calibration target 136) horizontally in the printer 100 to another XY location. For example, referring briefly to FIGS. 2A and 2B, the example stand 132 may include a third motor and/or a fourth motor in the base 206 that moves the post 208 in directions along X axis and/or Y axis, respectively, thereby enabling the calibration target 136 to be moved to other XY locations in the FoV. In other examples, a separate mechanism, such as a track system, may be disposed in the printer 100 and used to move the stand 132 laterally to different XY locations in the FoV.

Also, as disclosed above, a position of the calibration sequence may include a specific height or depth (along the Z axis) relative to the first and second cameras 122, 124. Therefore, in addition to or as an alternative to changing the tilt, rotation, and/or XY location of the calibration target 136, the stand 132 may be moved vertically (linearly) upward and/or downward, which enables more calibration images throughout the volume of space in the FoV and, thus, better calibration results. For example, the calibration executor 142 may instruct the platform controller 114 to move the build platform 102 up or down while the stand 132 is disposed on the build platform 102, thereby moving the calibration target 136 linearly toward or away from the first and second cameras 122, 124. In some examples, the build platform 102 is moved down to a level where the platform 200 (FIG. 2) of the stand 132 (and, thus, the calibration target 136) is about even with and/or lower than the level of the build platform 102 in the up position (the position shown in FIG. 1. As such, the calibration target 136 is disposed around the depth where the powder spread occurs and where the 3D object is formed, which is a beneficial location for obtaining calibration data. In other examples, the stand 132 may include a motor that moves the platform 200 (FIG. 2) linearly along the Z axis. For example, referring briefly to FIG. 2A, the stand 132 may include a third motor in the base 206 that moves the post 208 up or down relative to the base 206 and, thus, moves the platform 200 linearly along the Z (vertical) axis.

In some examples, the calibrator 134 includes a position determiner 148 that determines and/or otherwise selects the calibration position(s) that should be used for calibrating the stereo vision system 120. Each position may be defined by a specific orientation (rotation about the XYZ axes) of the calibration target 136 and/or location (in the XYZ frame) of the FoV. In some examples, the position determiner 148 determines the position(s) based on a type of the stereo vision system 120, a type of the printer 100, a size of the FoV, a time since a last calibration, and/or any other parameter of the stereo vision system 120 and/or the printer 100. In some examples, the position determiner 148 selects a position sequence based on a standard or guideline sequence used in other stereo vision calibration processes. Additionally or alternatively, a position sequence may be established and/or otherwise created via user input. For example, a user may manually enter the desired position(s) (e.g., defined by the rotational angles about the XYZ axes and/or location in the XYZ reference frame) to be included in the calibration process. Other example processes for determining the positions of a calibration sequence are disclosed in further detail herein.

The images obtained by the first and second cameras 122, 124 of the calibration target 136 are analyzed by a parameter determiner 150 of the calibrator 134 to determine various parameters of the stereo vision system 120 that are used during the depth extraction process, as disclosed in further detail herein. To ensure the accuracy of the calibration process, the calibrator 134 of FIG. 1 includes a calibration error calculator 152 that analyzes the calibration images and calculates a calibration error for each image set and/or a total calibration error for the sequence of calibration image sets. Because the parameters (e.g., location, position, grid size, etc.) of the calibration target are known for a certain position, the location of the points in the 2D image can be assumed. However, there are often differences between the expected location of the points in the 2D images and the actual location of the points in the 2D images, referred to as a reprojection error value e. The calibrator error calculator 152 may calculate the reprojection error value e for an image set using Equation 1 below.

$${e}_{i} = \frac{1}{n} {\sum }_{j = 1}^{n} ‖ {P}_{i} ( {X}_{j} ) - {x}_{j} ‖ \qquad Equation 1$$

In Equation 1, Pᵢ is the projection matrix of a camera for the i-th calibration view, xⱼ is the number of detected grid points, and Xⱼ is the planar points of the 3D world. In some examples, the calibration error calculator 152 calculates the quality of the calibration process by taking the root means square (RMS) of the target reprojection error values of all the calibration images for the sequence using Equation 2 below.

$$RMS = \sqrt{( {\sum }_{i} {e}_{i}^{2} )} / i \qquad Equation 2$$

The RMS calibration error value is useful measure of how well the calculated camera parameters correspond to the actual system setup. In some examples, only the results of a calibration sequence having a RMS calibration error value that meets a threshold error value are considered reliable. For example, if the RMS calibration error value is greater than a threshold error, the calibration sequence may not be considered reliable and the calibration sequence may need to be performed again. If the RMS calibration error value meets the RMS calibration error threshold (e.g., is below the threshold), the results may be considered reliable, and the parameters of the stereo vision system 120 may be calculated with confidence. In some examples, a RMS calibration error value of 0.1 is considered acceptable, while lower values, such as 0.03 are considered great. The example calibration system 130 disclosed herein can be used to achieve RMS calibration errors of down to 0.02 and even lower because of the accuracy, reliability, and repeatability of positions that can be performed with the example stand 132. With better calibration results, the example stereo vision system 120 can detect smaller variations in Z height more precisely (e.g., down to 4-5 microns).

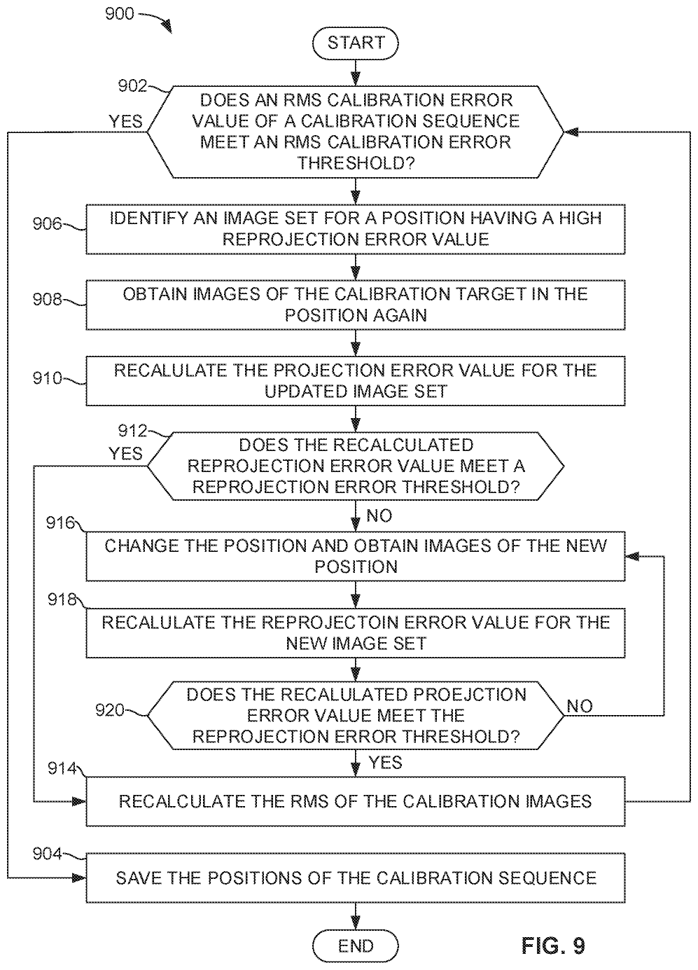

In some examples, the calibrator 134 includes a position optimizer 154 that identifies a position or a combination of positions that result in minimal calibration errors. The example position optimizer 154 may analyze the reprojection error value(s) of a position or a combination of positions of previously performed calibrations. In some examples, the position optimizer 154 compares the reprojection error value(s) to a reprojection error threshold. If the reprojection error value does not meet (e.g., is less than) the reprojection error threshold, the image set for that position may be retaken or the position may be changed. If the new position produces a better result, the new position is saved such that that the calibration sequence results in a more accurate calibration. The position optimizer 154 may save (e.g., in the database 144) these positions and/or combinations of positions as optimal positions to be used in subsequent calibrations. After multiple iterations, a calibration process may be refined over-and-over until a relatively accurate sequence of positions is achieved. An example process of minimizing calibration error is disclosed in connection with FIG. 9.

In some examples, the position optimizer 154 determines certain ones of the image sets to remove or delete from the analysis (e.g., because of a high error value that negatively effects the calibration process). Additionally or alternatively, the position optimizer 154 may determine certain positions and/or areas in the FoV that need additional calibration data. For example, the position optimizer may identify that a certain tilt angle produced high error results. The position optimizer 154 may determine one or a plurality of additional positions around the tilt angle so as to add more calibration data for this specific region or area.

As mentioned above, the parameter determiner 150 uses the results of the calibration process to estimate certain parameters of the stereo vision system 120 that may be used to establish a measurement reference frame in the 3D world coordinates, correct for lens distortions, and/or extract quantitative depth information from stereo image data during the printing process. As such, the calibration process directly impacts the accuracy of the stereo depth extraction technique. The parameters include intrinsic parameters of the cameras 122, 124, extrinsic parameters of the cameras 122, 124, and/or lens distortion coefficients of the cameras 122, 124. The lens distortion coefficients are used to correct for lens distortion, such that measurements taken from the images are reliable and accurate. The intrinsic parameters include the camera-specific geometric and optical characteristics, such as the equivalent lens focal length measured in pixels, the coordinates of the true optical center, and/or the pixel skew coefficient. Extrinsic parameters include the relative position and orientation of cameras 122, 124 in the 3D world coordinates, such as rigid body translation and rotation vectors of the cameras 122, 124. Together, the intrinsic and extrinsic parameters define the geometry used to determine the relationship between measured pixel disparity values and quantifiable Z height used by the image analyzer 126 when analyzing image sets. For example, Equation 3 below illustrates the stereo vision geometry used to extract depth information:

$$Z = \frac{fB}{D} \qquad Equation 3$$

In Equation 3, Z is the perpendicular distance from the cameras 122, 124 to the calibration target 136 (in meters), f is the lens focal length (in pixels), B is the baseline distance between the cameras 122, 124 (in meters), and D is the disparity between common features in stereo images (in pixels). The lens focal length f and the baseline distance B are the parameters determined via the stereo calibration process using the parameter determiner 150.

In some examples, the parameter determiner 150 determines the parameters algorithmically by analyzing a sequence of calibration images. In particular, the images depict a planar view of the calibration target 136 containing a known grid pattern and positioned at different tilts and orientations within the FoV of the cameras 122, 124. In some examples, the parameter determiner 150 analyzes the images based on the pinhole camera model to account for Seidel lens distortions. The pinhole camera model sets up a parametric fitting process to solve the correspondence problem between the 3D world coordinates and the analogous 2D image points. Moving the calibration target 136 around the FoV and, in some examples, introducing extreme amounts of out-of-plane tilt, improves the parametric fitting process by providing additional correspondence information between the 3D world coordinates and the 2D image points. The outputs of the pinhole correspondence problem are the intrinsic and extrinsic parameters. The Seidel modification leverages the constraint that the planar grid pattern should appear uniform in corrected calibration images to calculate the coefficients required to remove lens distortions from subsequence images taken with either of the cameras 122, 124. In other examples, the parameter determiner 150 may utilize other camera models or methodologies, such as a Direct Linear Transform (DLT), Tsai's method, and/or Zhang's method. In some examples, the calibration results remain valid as long as the camera focus, aperture setting, and relative positioning of the cameras 122, 124 remains the same. However, if adjustments are made to the cameras 122, 124, the stereo vision system 120, and/or the printer 100, the stereo vision system 120 should be recalibrated. The stereo vision system 120 may be calibrated before or after use. For example, the stereo vision system 120 could be calibrated after the stereo vision system 120 obtains images of the build process, and the determined parameter(s) may be used to analyze the images afterwards.

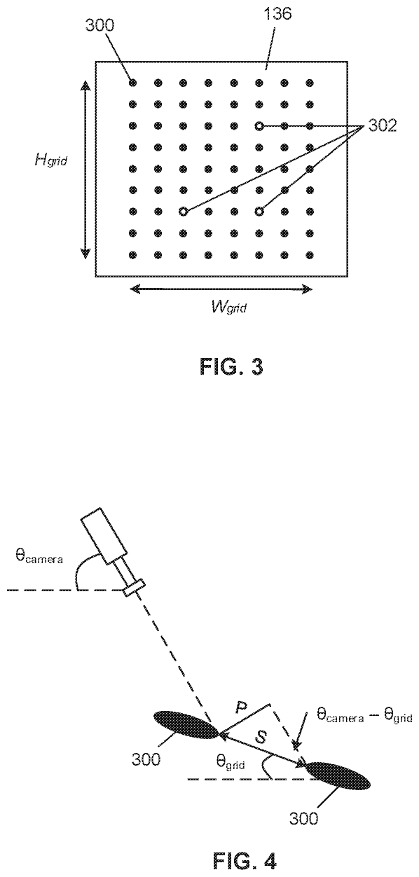

FIG. 3 illustrates the example calibration target 136 that may be used to calibrate the example stereo vision system 120 of FIG. 1. The calibration target has dimensions H_{grid} by W_{grid}. The calibration target 136 includes the grid pattern 220, which includes a plurality of solid dots 300 (one of which is labeled in FIG. 3) and three hollowed-out marker dots 302 (which may be used to determine the orientation of the calibration target 136). The dimensions, number of dots, and sizing and spacing are known ahead of time and may be entered into the calibrator 134 (e.g., via a keyboard of the computing device 112). Disclosed below are example factors that may be used to select an optimal calibration target, including the number of dots, the dot size, and/or the grid dimensions. In some examples, the calibrator 134 includes a target selector 156 (FIG. 1) that selects the parameters (e.g., grid size, dot size, dot spacing, etc.) of a calibration target based any of the factors and/or a combination of the factors. In some examples, the target selector 156 outputs the parameters of the calibration target on a screen of the computing device 112, such that a user can select the appropriate calibration target to use during the calibration process.

In some examples, the calibration error is inversely proportion to the number of dots contained in a calibration target. Therefore, in some instances, increasing the number of dots tends to improve calibration quality. However, there is a point of diminishing return when the dots become too small, or too closely spaced, to be accurately identified and processed by the calibrator 134.

In some examples, to achieve sufficient resolution of circular features for the purpose of image analysis, a standard of 9×9 pixels of resolving power is used, which translates to a dot diameter D of at least 9 pixels (i.e., 9 pixels multiplied by the camera spatial resolution). In some calibration targets, such as the calibration target 136 shown in FIG. 3, a number of marker dots are included that have hollowed-out centers for discerning orientation. As such, the minimum circular feature that should be considered for analysis is the inner dot diameter. Applying the minimum circular feature size constraint to an inner diameter d of the marker dots 302 results in Equation 4 below.

d≥9*(Camera Spatial Resolution) Equation 4

In this example, the optimal inner diameter ratio d/D is 0.4. This allows Equation 4 to be rewritten as Equation 5 below.

0.4D≥9*(Camera Spatial Resolution) Equation 5

Equation 6 gives the final expression for the minimum dot diameter as a function of camera spatial resolution.

D≥22.5*(Camera Spatial Resolution) Equation 6

Equation 6 provides a result that is sufficient for determining the minimum dot size requirement when camera spatial resolution is a limiting design factor. However, in other examples, the resolution of a camera may be much higher. For example, the printer 100 of FIG. 1 may have a resolution of 300 dots per inch (dpi), which equates to a spatial resolution of about 85 microns per dot. If it is assumed that the each dot represents a single image pixel, then the same minimum circular feature size criteria to determining the minimum dot diameter for printing using Equation 7.

D≥22.5*(Printer Spatial Resolution)=22.5*(0.085 mm)=1.9 Equation 7

This result means that if the spatial resolution of the stereo vision system 120 is below 85 microns per pixel, the minimum dot diameter should still be about 2 millimeters (mm) to assure that the circular features are accurately printed. If the spatial resolution of the stereo vision system 120 is above 85 micros, or if special high-resolution printing is being implemented, then the expression for minimum dot diameter as a function of camera spatial resolution provides an appropriate minimum dot diameter.

When determining dot spacing, the goal is to avoid a spacing that results in two more dots being processed as a single dot by the calibrator 134. The lower limit of dot spacing depends on the spatial resolution of the stereo vision system 120. The edge-to-edge dot spacing impacts the distinguishability of the individual dots, specifically when the calibration target 136 is subject to out-of-plane tilt (e.g., about the X (horizontal) axis). An example geometry for determining the minimum edge-to-edge dot spacing S is illustrated in FIG. 4. The dot spacing S is based on a camera operating angle θ_{Camera}, and an out-of-plane tilt angle θ_{grid}. P is the projected distance between the solid dots 300 on the 2D image plane. For each dot to remain distinguishable, the projected distance P should be larger than the spatial resolution of the stereo vision system 120, as shown in Equation 8 below.

P>Camera Spatial Resolution Equation 8

Solving for P in terms of the dot spacing S, according to the geometry shown in FIG. 4, is provided by Equation 9 below.

P=S sin(θ_{camera}−θ_{grid}) Equation 9

Solving for S to determine the minimum edge-to-edge dot spacing for a given camera system is given by Equation 10 below.

$$S > \frac{Camera Spatial Resolution}{sin ( {θ}_{camera} - {θ}_{grid} )} \qquad Equation 10$$

Considering an extreme case, where the minimum difference between the camera and the grid angles is less than 1 degree and the spatial resolution of the stereo vision system 120 is 48 microns per pixel, the above criteria suggests adhering to the dot spacing S shown below.

$$S > \frac{0.048 \frac{mm}{pixel}}{sin ( 1 ° )} = 2.75 mm$$

Alternatively, the above expression can be used to determine a limit on tilt angle that retains dot distinguishability for a given spacing. For instance, dropping the pixel⁻¹ term from the units does not change the meaning of the above result.

Another consideration is the calibration target dimensions. In some examples, a calibration target that is approximately 50-75% of the camera FoV is selected. In some instances, smaller grids present challenges in terms of adequately calibrating the entire FoV after reasonable number of iterations, and larger grids become difficult to keep within the camera FoV while also achieving a sufficient amount of target variation. In other examples, a calibration target having smaller or larger dimensions is selected.

In some examples, the position determiner 148 of the calibrator 134 determines and/or otherwise selects the positions and/or sequences of positions for the calibration target 136 based on various factors. For example, the position determiner 148 may consider that the goal of the calibration process is to determine the relationship between the 3D world coordinates and the corresponding 2D image points. When the grid dots are distributed largely out-of-plane, the parametric fitting process can more confidently decipher how the volume of space in the real word is being projected onto the image plane. As such, subjecting the calibration target to extreme out-of-plane tilts may improve the calibration process. Therefore, the position determiner 148 may select more out-of-plane tilt positions.

As another example, the position determiner 148 may consider that there is benefit to applying intermediate tilts to the calibration target 136. While extreme out-of-plane tilts may provide information about what is happening across a large space of the imaging space, intermediate tilt positions (between vertical and horizontal) improve upon the quantity of information provided at each particular depth of the image volume.

As another example, the position determiner 148 may consider that the camera parameters are directionally dependent. Therefore, in some examples, the calibration target is subjected to changes in tilt and orientation equally in both planar coordinate directions, which ensures that there is minimal directional discrepancy in the calibration quality. In some examples, the position determiner 148 may consider the calibration is spatially dependent. In some examples, positions are selected such that the grid pattern is present at every location within the camera FoV in the aggregate of the calibration image data. This may improve the calibration results by considering an estimation of the system parameters in each region of the image space.

As disclosed above, in some examples, extreme angles of out-of-plane tilt may benefit the calibration process by supplying a greater range of 3D world coordinate information to solve the correspondence problem. However, at some angle, the grid pattern 220 becomes obstructed or even defocused in one or both of the cameras 122, 124. In either case, the particular calibration image set may be rendered useable. As such, in some examples, the position determiner 148 may use constraints when determining limitations on tilt angle for a calibration sequence.

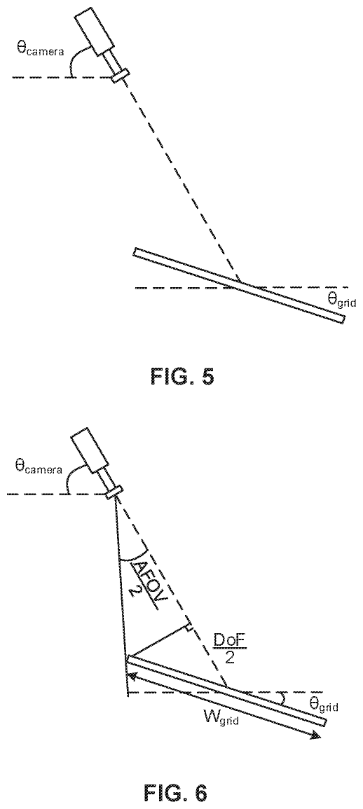

One constraint, for example, considers that after applying out-of-plan tilt to the calibration target 136, the grid pattern 220 should remain visible in both of the cameras 122, 124. For example, referring to FIG. 5, the out-of-plane tilt angle should be less than the operating angle of the camera (θ_{grid,max}<θ_{camera}), which may correspond to the first or second cameras 122, 124.

Another example constraint considers that after applying out-of-plane tilt to the calibration target 136, the grid pattern 220 should remain in focus in both of the cameras 122, 124 (FIG. 1). In other words, the calibration target 136 should not be subjected to a tilt that would cause the grid pattern to extend out-of-plane beyond the depth of field (DoF) of the stereo vision system 120. In some examples, this constraint is relevant when the dimensions of the grid pattern 220 are larger than the camera DoF. For example, referring to FIG. 6, to determine how this constrain limits the out-of-plane tilt angle, the grid angle θ_{grid} is to be expressed in terms of camera DOF, which is shown in Equation 11 below.

$$cos ( {θ}_{camera} - {θ}_{grid} ) = \frac{DoF}{{W}_{grid}} \qquad Equation 11$$

Rearranging Equation 11 to isolate the out-of-plane tilt angle yields and applying the mathematical focus constraint yields is given by Equation 12 below.

$${θ}_{grid , max} < {θ}_{camera} - {cos}^{- 1} ( \frac{DoF}{{W}_{grid}} ) \qquad Equation 12$$

The expression in Equation 12 is valid when W_{grid}>DoF. Otherwise, the maximum out-of-plane tilt angle should adhere to the previous constraint of θ_{grid,max}<θ_{camera}.

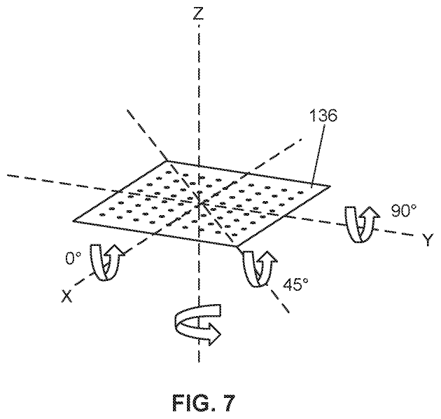

The position determiner 148 may select any number of positions to obtain calibration images. In some examples, the position determiner 148 selects a sequence of at least 27 positions. For example, this may correspond to three sets of nine out-of-plane tilts with orientations of 0°, 45°, and 90° of the calibration target 136 within the FoV, as illustrated in FIG. 7. In some examples, the tilt angles are equally distributed within the range of −θ_{grid, max} to +θ_{grid, max}, which equates to increments of 2θ_{grid}/9. An example set of tilts may be, for example, −40°, −30°, −20°, −10°, 0°, +10°, +20°, +30°, +40°, where each of the tilts may be performed at 0°, 45°, and 90° around the Z (vertical) axis, as illustrated in FIG. 7. In other examples, the tilt angle range (−θ_{grid,max} to +θ_{grid,max}) may be larger or smaller. For example, another example set of tilts with a tilt angle range ±15° may be −15°, −10°, −5°, −2.5°, 0°, +2.5°, +5°, +10°, +15°. In other examples, a calibration sequence may include position(s) with other orientations (rotations about the XYZ axes) and/or linear locations (along the XYZ axes) of the calibration target 136, which may be implemented by the stand 132 (FIG. 1). As such, the example calibration system 130 may be used to accurately position the calibration target 136 in various positions for calibrating the stereo vision system 120.

In some examples, the stereo vision system 120 of the printer 100 may only need to be calibrated once. As long as the relative positions of the cameras 122, 124, the focal length, etc. remain relatively the same, the calibration parameters should remain valid. However, if any of the parameters of the stereo vision system 120 are changed, the stereo vision system 120 should recalibrated. The example stand 132 disclosed herein is portable and can be easily used to calibrate the stereo vision system 120 at any time. Additionally, the example stand 132 can be similarly used in other printers. In some examples, once an AM machine is set up (e.g., in a laboratory or workshop), the example calibration system 130 is used to calibrate the AM machine. Additionally or alternatively, when manufacturing the AM machine, for example, the stereo vision system may be calibrated after the stereo vision system is installed in the printer 100. Thus, the example calibration system 130 disclosed herein provides an easy, simple calibration.

While the examples disclosed herein are described in connection with a stereo vision system having two cameras, in other examples, the stereo vision system 120 may have more than two cameras. In some instances, the use of additional cameras may assist with feature recognition by reducing the stereo angle between cameras. For example, a third camera may be disposed between the first and second cameras 122, 124. In such an example, an incremental correlation may be performed between the first camera 122 and the third camera, and then between the third camera and the second camera 124. As such, disparity measurements may be made with more certainty and yield depth measurements with higher reliability. In another example, an array of microelectromechanical systems (MEMS) cameras may be employed to obtain equivalent (or higher) spatial resolution at a reduced cost In such an example, the aggregate of image data may be stitched together and subsequently used for calibration or each individual MEMS camera pair may be calibrated individually. Further, in other examples, instead of a two camera system, a single camera may be used that is moved to different vantage points to create the stereoscopic effect, or a camera system having dual lens with a single camera sensor may be used.

While an example manner of implementing the calibrator 134 is illustrated in FIG. 1, any of the elements, processes and/or devices illustrated in FIG. 1 may be combined, divided, re-arranged, omitted, eliminated and/or implemented in any other way. Further, the example calibration executor 142, the example position determiner 148, the example parameter determiner 150, the example calibration error calculator 152, the example position optimizer 154, the example target selector 156, and/or, more generally, the example calibrator 134 of FIG. 1 may be implemented by hardware, software, firmware and/or any combination of hardware, software and/or firmware. Thus, for example, any of the example calibration executor 142, the example position determiner 148, the example parameter determiner 150, the example calibration error calculator 152, the example position optimizer 154, the example target selector 156, and/or, more generally, the example calibrator 134 could be implemented by any analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example calibration executor 142, the example position determiner 148, the example parameter determiner 150, the example calibration error calculator 152, the example position optimizer 154, and/or the example target selector 156 is/are hereby expressly defined to include a non-transitory computer readable storage device or storage disk such as a memory, a digital versatile disk (DVD), a compact disk (CD), a Blu-ray disk, etc. including the software and/or firmware. Further still, the example calibrator 134 of FIG. 1 may include other elements, processes and/or devices in addition to, or instead of, those illustrated in FIG. 1, and/or may include more than one of any or all of the illustrated elements, processes and devices.

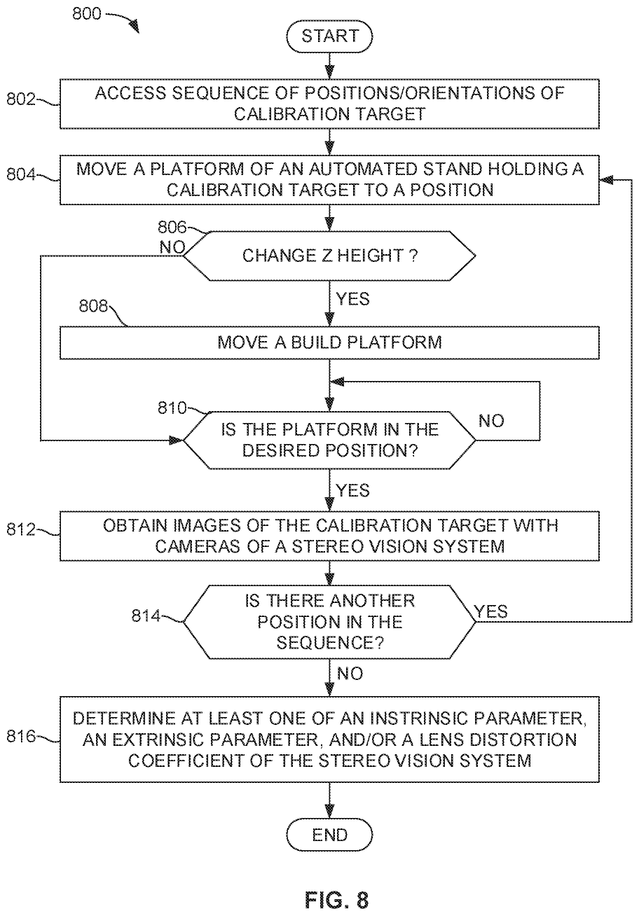

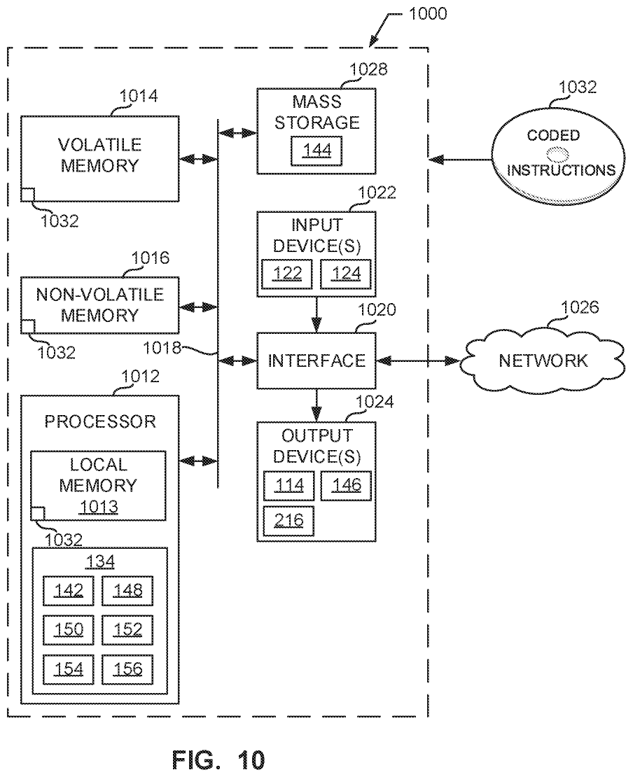

Flowcharts representative of example machine readable instructions for implementing the calibrator 134 of FIG. 1 are shown in FIGS. 8 and 9. In this example, the machine readable instructions comprise a program for execution by a processor such as the processor 1012 shown in the example processor platform 1000 discussed below in connection with FIG. 10. The program may be embodied in software stored on a non-transitory computer readable storage medium such as a CD-ROM, a floppy disk, a hard drive, a digital versatile disk (DVD), a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowcharts illustrated in FIGS. 8 and 9, many other methods of implementing the example calibrator 134 may alternatively be used. For example, the order of execution of the blocks may be changed, and/or some of the blocks described may be changed, eliminated, or combined. Additionally or alternatively, any or all of the blocks may be implemented by a hardware circuit (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example processes of FIGS. 8 and 9 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

FIG. 8 is a flowchart 800 representative of example machine readable instructions that may be executed by the computing device 112 of the printer 100 to implement the example calibrator 134 of FIG. 1 to perform an example calibration process. Prior to performing the calibration process, the calibration target 136 is coupled to the platform 200 of the stand 132 and the stand 132 is placed into the FoV of the stereo vision system 120 on the build platform 102. In some examples, the stand 132 is plugged into computing device 112 via the cable 138 to send and/or receive data. In other examples, the stand 132 may be wirelessly synced with the computing device 112.

At block 802, the position determiner 148 accesses a sequence of positions or orientations to be used for obtaining calibration images. At block 804, the calibration executor 142 controls the stand 132, via a command signal, to move the platform 200 (and, thus, the calibration target 136) to a first position in the sequence of positions. The movement may include rotating the platform 200 about the X (horizontal) axis via the second motor 214 and/or the Z (vertical) axis via the first motor 210. In some examples, the stand 132 may have another degree of freedom to rotate the platform 200 about the Y axis. In such an example, moving the platform 200 may including rotating (e.g., via motor) the platform 200 about the Y axis. At block 806, the calibration executor 142 determines whether the first position includes a change in Z height of the calibration target 136. In some such examples, to control the Z height, the calibration executor 142 moves the build platform 102 of the printer 100 up or down (e.g., via the platform controller 114) to position the platform 200 (and, thus, the calibration target 136) at the desired Z height, at block 808. In other examples, the stand 132 may include a motor to move the platform 200 (and, thus, the calibration target 136) linearly along the Z (vertical) axis. Otherwise, control proceeds to block 810.

At block 810, the calibration executor 142 determines whether the platform 200 and/or the calibration target 136 is in the first position. In some examples, the calibration executor 142 determines whether the platform 200 is in the desired position based on a return signal from the stand 132. For example, once in the desired position or orientation, the motor controller 216 of the stand 132 may send a signal (e.g., based on feedback from the servo motors) to the calibrator 134 that the platform 200 is in the desired position. Likewise, if the build platform 102 is being used to change the Z height of the stand 132, the platform controller 114 may send a signal to the calibrator 134 once the build platform 102 is at the desired Z height. If the calibration target 136 is not in the desired position, the calibration executor 142 waits for the stand 132 and/or the build platform 102 to complete their movement.

Once the platform 200 (and, thus, the calibration target 136) are in the first position, the calibration executor 142, at block 812, controls the stereo vision system 120 (e.g., via the camera controller 146) to obtain images (i.e., an image set) of the calibration target 136 with the first and second cameras 122, 124. At block 814, the calibration executor 142 determines whether there are other positions in the sequence. If there is another position in the sequence, control returns to block 804 and the calibration executor 142 moves the stand 132 and/or the build platform 102 to position the calibration target 136 in the next position in the sequence of positions. This process may be repeated for each position until images of the calibration target 136 are obtained for each position in the sequence.

At block 816, the parameter determiner 150 determines at least one of an intrinsic parameter, an extrinsic parameter, and/or a lens distortion coefficient of the stereo vision system 120, using a camera model based on the image set(s) from the calibration process. In some examples, the parameter determiner 150 uses the pinhole camera model to determine the parameter(s). Additionally or alternatively, the parameter determiner 150 may use another camera model, such as the pinhole camera model, a Direct Linear Transform (DLT), Tsai's method, and/or Zhang's method. These parameter(s) may then be used by the stereo vision system 120 when extracting depth information during the printing process.

In some examples, the calibration sequence may not result in images of the calibration target 136 in all areas of FoV of the stereo vision system 120. Therefore, in some examples, after a first calibration sequence is performed with the stand 132 in a first XY location in the printer 100, the stand 132 may be moved to a second XY location on the build platform 102 and a second, subsequent calibration sequence may be performed. In some examples, the stand 132 includes additional degrees of freedom to move the platform 200 (and, thus, the calibration target 136) horizontally. For example, the stand 132 may include additional motors to move the post 208 along the X and/or Y axes, thereby changing the XY location of the calibration target 136 in the FoV. Therefore, in some examples, moving the platform 200 to the desired position (e.g., at blocks 804-808) may include translating the platform 200 horizontally to the desired XY location. In some examples, the stand 132 is moved to multiple different XY locations on the build platform 102 during a calibration sequence. In other examples, one XY location may be sufficient.

In some examples, prior to determining the system parameters at block 816, the calibration error calculator 152 calculates an overall error value (e.g., a RMS calibration error value) for the calibration images and, if the error value does not meet a desired error threshold, certain ones of the image sets may be retaken and/or the corresponding position(s) may be changed. An example process to update an image set and/or position is disclosed in further detail in connection with FIG. 9 below.

FIG. 9 is a flowchart 900 representative of example machine readable instructions that may be executed by the computing device 112 to implement the calibrator 134 of FIG. 1. As mentioned above, prior to determining the system parameters at block 816 of FIG. 8, the calibration error calculator 152 may calculate an RMS calibration error value (e.g., using Equation 2) for the calibration images of the sequence of positions. At block 902, the calibration error calculator 152 determines whether the RMS calibration error value for a calibration sequence meets an RMS calibration error threshold, such as 0.1. If a user desires a more accurate calibration, the threshold can be lowered. In some examples, the RMS calibration error threshold is based on a type of the AM machine. For example, some AM machines may desire more precision and, thus, may have use a lower RMS calibration error threshold when calibrating the stereo vision system. If the RMS calibration error value meets (e.g., is equal to or greater than) the RMS calibration error threshold, the sequence of positions is saved at block 904 and the example process ends. In such an example, the positions of the sequence can be considered reliable and may be used in subsequent calibration process for other the same AM machine and/or another AM machine.

If the RMS calibration error value does not meet (e.g., is less than) the RMS calibration error threshold (determined at block 902), the calibration error calculator 152 identifies an image set for a position of the calibration sequence that has a relatively high reprojection error value at block 906. As mentioned above, a reprojection error value may be calculated using Equation 1 for each of the image sets. In some examples, an image set having the highest reprojection error is identified. Additionally or alternatively, the calibration error calculator 152 may compare the reprojection error values to a reprojection error threshold, and if a reprojection error value does not meet (e.g., is below) the reprojection error value, the image set is identified as having a high reprojection error value at block 906.

At block 908, the calibration executor 142 controls the stand 132 to move the calibration target 136 to the position and controls the cameras 122, 124 to obtain another image set of the calibration target 136. At block 910, the calibration error calculator 152 recalculates the reprojection error value (e.g., using Equation 1) for the updated image set. At block 912, the calibration error calculator 152 determines whether the recalculated reprojection error value meets the reprojection error threshold. If the recalculated reprojection error value meets (e.g., is equal to or above) the reprojection error threshold, at block 914, the calibration error calculator 152 recalculates the RMS calibration error value for the calibration sequence and control returns to block 902.

If the recalculated reprojection error value does not meet (e.g., is below) the reprojection error threshold, at block 916, the position optimizer 154 determines a new position for the calibration target 136, which may be a small change (e.g., ±2° rotation) in the position with respect to the current position. The calibration executor 142 controls the stand 132 to move the calibration target 136 to the new position and controls the cameras 122, 124 to obtain a new image set of the calibration target 136 in the new position. At block 918, the calibration error calculator 152 recalculates the reprojection error value for the new image set. At block 920, the calibration error calculator 152 determines whether the recalculated projection error value meets the reprojection error threshold. If the projection error value of the new image set does not meet (e.g., is less than) the reprojection error threshold, control returns to block 916 and the position optimizer 154 may determine another change to the position. This process may continue numerous times until the position optimizer 154 identifies a position that results in a desired reprojection error value. If the reprojection error value of the new image set does meet (e.g., is equal to or greater than), the calibration error calculator 152, at block 914, recalculates the RMS calibration error value for the calibration sequence and control returns to block 902. This process may continue numerous times until the RMS calibration error value satisfies the RMS calibration error threshold. This process also helps identify optimal positions and/or combinations of positions that produce low calibration errors and, thus, accurate calibration results. These positions and/or combinations of positions may be used in subsequence calibrations of the same AM machine and/or another AM machine.

FIG. 10 is a block diagram of an example processor platform 1000 capable of executing the instructions of FIGS. 8 and 9 to implement the calibrator 134 of FIG. 1. The processor platform 1000 can be, for example, a server, a personal computer (e.g., such as the computing device 112), a mobile device (e.g., a cell phone, a smart phone, a tablet such as an iPad™), a personal digital assistant (PDA), a DVD player, a CD player, or any other type of computing device.

The processor platform 1000 of the illustrated example includes a processor 1012. The processor 1012 of the illustrated example is hardware. For example, the processor 1012 can be implemented by an integrated circuit, a logic circuit, a microprocessor or a controller from any desired family or manufacturer. The hardware processor may be a semiconductor based (e.g., silicon based) device. In this example, the processor 1012 may implement the calibration executor 142, the example position determiner 148, the example parameter determiner 150, the example calibration error calculator 152, the example position optimizer 154, the example target selector 156, and/or, more generally, the example calibrator 134.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, input devices 1022 are connected to the interface circuit 1020. The input device(s) 1022 permit(s) a user to enter data and/or commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system. In this example, the input device(s) 1022 may include the first and/or second cameras 122, 124.

Output devices 1024 are also connected to the interface circuit 1020 of the illustrated example. The output device(s) 1024 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1020 of the illustrated example, thus, typically includes a graphics driver card, a graphics driver chip and/or a graphics driver processor. In this example, the output device(s) 1024 may include the platform controller 114, the camera controller 146, and/or the motor controller 216.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes mass storage devices 1028 for storing software and/or data. Examples of such mass storage devices 1028 include floppy disk drives, hard drive disks, compact disk drives, Blu-ray disk drives, RAID systems, and digital versatile disk (DVD) drives. The mass storage device 1028 may include, for example, the database 144.

Coded instructions 1032 of FIGS. 8 and 9 may be stored in the mass storage device 1028, in the volatile memory 1014, in the non-volatile memory 1016, and/or on a removable tangible computer readable storage medium such as a CD or DVD.

From the foregoing, it will be appreciated that example methods, apparatus, systems, and articles of manufacture have been disclosed that improve the accuracy of stereo vision calibration, including stereo vision systems in AM machines. The example automated calibration target stands disclosed herein enable high accuracy, reliability, and repeatability in moving a calibration target through a sequence of positions. The examples disclosed herein enable an un-skilled or trained user to be able to calibrate a stereo vision system. Examples disclosed herein can also be used to iteratively refine and update positions that result in low calibration error, thereby further improving the calibration process. While the examples disclosed herein are described in connection with 3D printing or AM machines, the example methods, apparatus, systems, and articles of manufacture disclosed herein can similarly be used with stereo vision systems in other applications not relating to 3D printing.

Although certain example methods, apparatus, systems, and articles of manufacture have been disclosed herein, the scope of coverage of this patent is not limited thereto. On the contrary, this patent covers all methods, apparatus, systems, and articles of manufacture fairly falling within the scope of the claims of this patent.

What is claimed is:

1. A stereo vision calibration system comprising:
an automated calibration target stand to support a calibration target; and
a calibrator to:
control the automated calibration target stand to move the calibration target to a plurality of positions according to a sequence of positions while the automated calibration target stand is disposed in an additive manufacturing (AM) machine; and
control a stereo vision system of the AM machine to obtain images of the calibration target in the plurality of positions.

2. The stereo vision calibration system of claim 1, wherein the calibrator is to control a moveable build platform in the AM machine to move the automated calibration target stand vertically upward or downward.

3. The stereo vision calibration system of claim 1, further including a computing device associated with the AM machine, the calibrator implemented by the computing device.

4. The stereo vision calibration system of claim 3, wherein the automated calibration target stand is powered by an input/output (I/O) port on the computing device.

5. The stereo vision calibration system of claim 1, wherein the automated calibration target stand includes a base, a post extending from the base, and a platform coupled to the post via a joint, the joint defining a horizontal axis of rotation, the calibration target to be coupled to the platform.

6. The stereo vision calibration system of claim 5, wherein the automated calibration stand includes a first motor disposed in the base to rotate the post, thereby rotating the platform about a vertical axis, and a second motor disposed in the joint to rotate the platform about the horizontal axis.

7. The stereo vision calibration system of claim 1, wherein the AM machine comprises a build platform to receive a layer of powder material and a fusing agent.

8. The stereo vision calibration system of claim 1, wherein the calibrator is to determine at least one of an intrinsic parameter, an extrinsic parameter, or a lens distortion coefficient of the stereo vision system using a camera model based on the images of the calibration target.

9. A non-transitory machine readable storage medium comprising instructions that, when executed, cause at least one machine to at least:
move an automated calibration target stand holding a calibration target to position the calibration target in a desired orientation, the automated calibration target stand disposed in a field of view of a stereo vision system in an additive manufacturing (AM) machine; and
in response to determining the calibration target is in the desired orientation, obtain an image set of the calibration target in the desired orientation with the stereo vision system.

10. The non-transitory machine readable storage medium of claim 9, wherein the desired orientation is a first desired orientation and the image set is a first image set, and wherein the instructions, when executed, further cause the at least one machine to:
move the automated calibration target stand to position the calibration target in a second desired orientation; and
in response to determining the calibration target is in the second desired orientation, obtain a second image set of the calibration target in the second desired orientation with the stereo vision system.

11. The non-transitory machine readable storage medium of claim 10, wherein the instructions, when executed, further cause the at last one machine to calculate a root means square (RMS) calibration error value based on the first and second image sets.

12. The non-transitory machine readable storage medium of claim 9, wherein the image set is a first image set, and wherein the instructions, when executed, further cause the at least one machine to:
calculate a reprojection error value for the first image set; and
if the reprojection error value does not meet a reprojection error threshold, obtain a second image set of the calibration target in the desired orientation with the stereo vision system.

13. The non-transitory machine readable storage medium of claim 9, wherein the instructions, when executed, further cause the machine to determine at least one of an intrinsic parameter, an extrinsic parameter, or a lens distortion coefficient of the stereo vision system using a camera model based on the image set.

14. The non-transitory machine readable storage medium of claim 9, wherein the instructions, when executed, further cause the at least one machine to move a build platform of the AM machine upward or downward while the automated calibration target stand is disposed on the build platform.

15. The non-transitory machine readable storage medium of claim 9, wherein the automated calibration target stand is to move the calibration target by rotating the calibration target about at least one of a horizontal axis or a vertical axis.
